(19) United States
(12) Patent Application Publication
(10) Pub. No.: US 2004/0093298 A1
(43) Pub. Date: May 13, 2004

(54) Method for providing energy commodities trade outsourcing services within the energy markets

(76) Inventors: Robert E. McClure III, Suwanee, GA (US); John W. Ragan, Dunwoody, GA (US); Scott Robinson, Leesburg, VA (US)

Correspondence Address: Gregory Scott Smith, P.O. Box 88148, Atlanta, GA, 30356, US

(21) Appl. No.: 10/289,596

(22) Filed: Nov. 7, 2002

(51) Int. Cl. G06F 17/60

(52) U.S. Cl. 705/37; 705/30

(57) ABSTRACT

A cost-effective method for providing transactional and value-add services for trading energy commodities by providing a viable solution plus a value proposition that is being sought by energy producers, distributors, marketers and consumers but has not yet been introduced to the energy marketplace. Customers or trading entities of these outsourcing services are likely to include, but are not limited to, energy producers, distributors, marketers, and consumers that are or would like to be involved in trading. Other potential customers are the large financial institutions that lack the expertise in physical scheduling and delivery. These services can be offered by a single standalone entity or jointly with a plurality of partners. These services are provided to a trading entity through a method of capturing a trade into a trade life cycle process, confirming the trade, determining whether the trade is financial or physical, if physical scheduling delivery of the commodity, closing the trade, and preparing applicable reports and data files. Value added services can also be provided to the trading entity such as research and modeling services, asset optimization services, risk management services, and contract administration services.

### TECHNICAL FIELD

The present invention relates to the field of energy commodities and, more particularly, to a method for providing outsourcing services related to energy commodities trade processing.

### BACKGROUND OF THE INVENTION

The energy commodity trading business is focused on trading energy commodities such as, but not limited to, electricity, natural gas, coal, heating oil, emissions, weather, etc. The trading of energy commodities is very complicated due to the difficulties associated with the physical delivery and accountability of these commodities.

The future of energy commodity marketing and trading, of course, is changing. Trading organizations will still be market participants but will have to show definite results. Trading organizations will look for ways to improve performance, achieve cost savings and avoid high dollar capital investments. With new Federal Energy Regulatory Commission (FERC) rules, Security Exchange Commission (SEC) report regulations, and Federal Accounting Standards Board (FASB) regulations, trading organizations need to be able to effectively integrate and customize disparate systems to efficiently operate. This is difficult and inefficient and requires a level of knowledge about risk management that many companies do not possess.

An opportunity exists within the energy industry to provide outsourcing services related to energy commodity trade processing; however, a viable solution has yet to be introduced into the energy marketplace. Such outsourcing services can provide the value proposition that is being sought by energy producers, distributors, marketers and consumers.

This outsourcing opportunity includes transactional processing as well as value-added services related to energy commodities trading. Potential value propositions for this invention are improved performance with fewer errors and improved productivity, cost savings, and avoidance of high-cost capital investments. Customers for these services are likely to include, but are not limited to, energy producers, distributors, marketers, and consumers that are or would like to be involved in energy commodities trading. Other potential customers are the large financial institutions, which generally lack expertise in physical scheduling and delivery.

Prime brokerage and correspondent clearing are very attractive lines of business for the financial services industry. Both include outsourced trade execution, clearing, settlement, and reporting, but tailor these services to different customers, typically hedge funds and small retail investment brokers.

This needed business differs from the traditional financial brokerage service because market participants are typically the transactors, i.e., they take positions on their own account as opposed to acting as agents. Also market participates can be both financial and physical players in the energy and energy related commodity business, unlike the brokerage firms which generally focus on the financial trades. Market participates typically price the trades/transactions, as opposed to a traditional brokerage firm, which strives to bring two parties together with a view to enabling a mutually beneficial trade and thereby earning a brokerage fee or commission. Physical and financial risk control and management of the energy commodities business are a value added aspect of this needed business. Prices for complex transactions can be designed to meet the needs of different types of counter-parties and then hedge the transaction risks through a series of steps involving the breaking of the transactions into appropriate risk categories, laying off the risks in the market. Therefore, there is a need in the art for a method of providing a prime brokerage and correspondent clearing like services within the energy commodity market.

### SUMMARY OF THE INVENTION

The present invention is directed towards solving the aforementioned needs in the art, as well as other needs in the art, by providing outsourcing services related to energy commodities trade processing. This outsourcing opportunity includes transactional processing as well as value-added services related to energy commodities trading. Potential value propositions for this invention are improved performance with fewer errors and improved productivity, cost savings, and avoidance of high-cost capital investments. Customers for these services are likely to include, but are not limited to, energy producers, distributors, marketers, and consumers that are or would like to be involved in energy commodities trading. Other potential customers are the large financial institutions, which generally lack expertise in physical scheduling and delivery. Potential customers of such outsourcing services will be referred to as trading entities throughout the remainder of this document.

This invention is a method for providing outsourcing services to a plurality of trading entities. These services can be offered by a single standalone entity or jointly with a plurality of partners. These services are provided to a trading entity through a method of capturing a trade into a trade life cycle process, confirming the trade, determining whether the trade is financial or physical, if physical scheduling delivery of the commodity, closing the trade, and preparing applicable reports and data files. Other services that can be offered are calculating price curves to provide information to the plurality of trading entities, performing valuation analysis and risk analysis based on trade entry and market parameters.

The energy commodity business is further complicated by the delivery of the physical commodities. This outsourcing service will assist trading entities in delivery of physical commodities. The steps of scheduling the delivery of the commodity involves the scheduling of the delivery, balancing positions, providing access to transportation logistics, and drawing on transport contracts.

The present invention is further enhanced by providing a trading entity with research and modeling services, asset optimization services, risk management services, and contract administration services.

### BRIEF DESCRIPTION OF THE DRAWINGS

FIG. 1 is a flow diagram illustrating a method for providing outsourcing services related to energy commodities trade processing.

FIG. 2 is a block diagram illustrating the implementation of the present invention in a joint venture structure.

### DETAILED DESCRIPTION

Turning now to the figures in which like numerals represent like elements throughout the several views, several exemplary embodiments of the present invention are described.

The present invention provides a cost-effective method for providing transactional and value-add services for trading energy commodities. To lock in prices, traders buy and sell forward contracts. Those contracts enable utilities and marketers to try to protect future revenue streams if they are the sellers of electricity, gas, or other energy commodities. Or, they may assure the right to buy such energy at a fixed price in the future, regardless of its cost at the time of delivery. When the contracts come to expiration, cash or physical settlement will occur.

Energy commodity marketers take advantage of pricing discrepancies and act as risk intermediaries. Their task is to find opportunities where the cost of the commodity is low and to sell it where it is high, making profits on those differentials. Their presence is intended to create price transparency, inspire competition and put downward pressure on prices.

The future of energy commodity marketing and trading, of course, is changing. Trading organizations will still be market participants but will have to show definite results. Trading organizations will look for ways to improve performance, achieve cost savings and avoid high dollar capital investments. With new Federal Energy Regulatory Commission (FERC) rules, Security Exchange Commission (SEC) report regulations, and Federal Accounting Standards Board (FASB) regulations for accounting for energy derivatives, trading organizations need to be able to effectively integrate and customize disparate systems to efficiently operate. This is difficult and inefficient and requires a level of knowledge about risk management that many companies do not possess. The present invention provides the value proposition that is being sought by energy producers, distributors, marketers and consumers.

In accordance with embodiments of the present invention, possible services within an energy commodities trade outsourcing business are:

Trade capture, execution, and booking

Access to transportation logistics (electricity transmission or gas pipelines)

Scheduling services

Optimize delivery by region and point

Nominate, allocate and schedule delivery

Receive report of product movement

Demand management for power or natural gas (load shaped products)

Delivery guarantee services

Information services (customized subscriptions, etc.)

Trade control and reporting

Basic reporting

Monitor exposure against limits and capital at risk

Develop reports for performance evaluation

Deal Confirmation

Verify deal terms

Confirm deal execution

Curve verification and translation to mark-to-market accounting (MTM)

Hedge treatment and Hedge Effectiveness testing (FASB 133)

Counter-party credit analysis

Contract administration

Settlement

Bill issuance, payment, and collection

Reconciliation against physical delivery

Financial accounting and administration

Risk Management

Research and modeling

Asset Optimization

Contract Administration

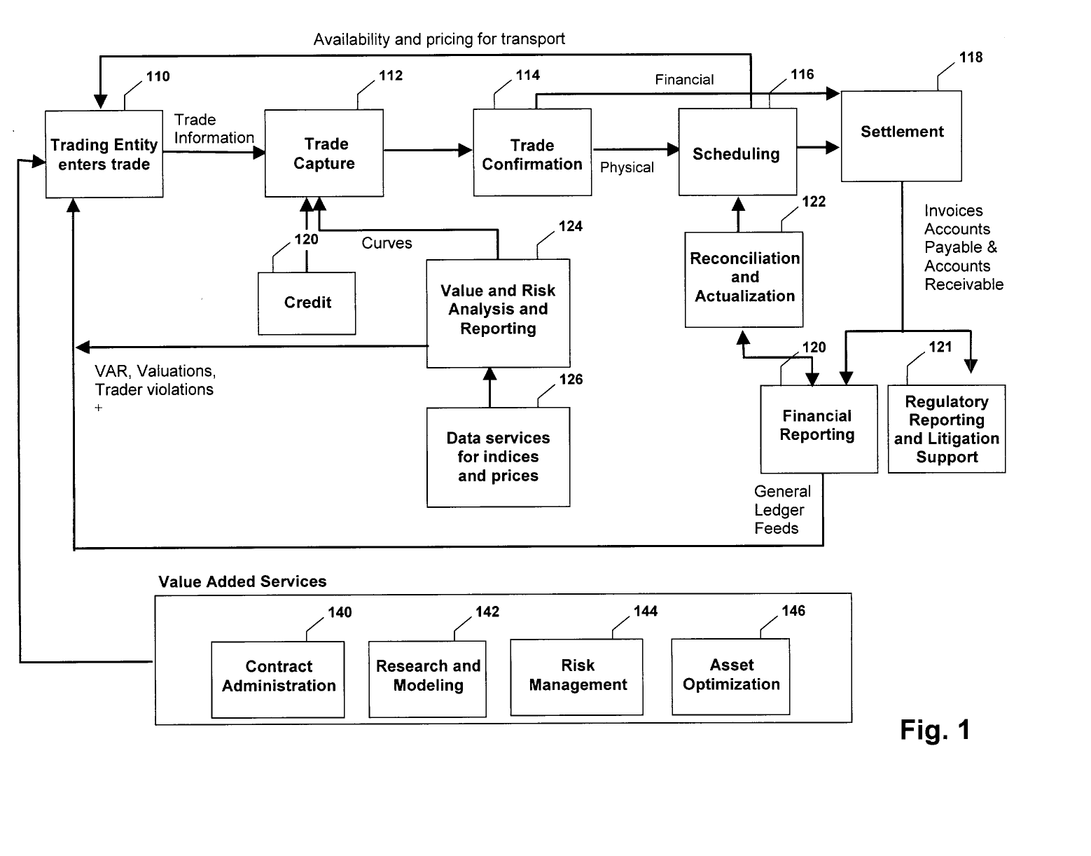

FIG. 1 is a flow diagram illustrating a method for providing outsourcing services related to energy commodities trade processing. Each block in FIG. 1 represents a function that can be performed by an outsourced trading company providing a trade life cycle process and can be implemented by software, human resources, or a combination of both. Customers of these outsourcing services are likely to include, but are not limited to, energy producers, distributors, marketers, and consumers that are or would like to be involved in trading. Other potential customers are the large financial institutions that lack the expertise in physical scheduling and delivery. Potential customers of such outsourcing services will be referred to as trading entities throughout the remainder of this document.

A trade is a deal between a trading entity and counter-party. In general, a trade is executed, captured and scheduled, confirmed and valued, checked-out, invoiced, and collected or paid. More specifically, a trading entity constructs a trade entry 110 for delivery to the outsourcing service. Each trade entry 110 is consummated by the trade information being captured via the trade life cycle process and includes, but is not limited to, a counter-party, trade identification, delivery location, type of transaction (purchase, sale, option, swap, etc.), volume, price, broker, and term. The trade entry is captured by the trade life cycle process in block 112. The capture function is optional and can include functions such as validating the information included in the trade entry 110. At the end of each trading day or periodically, a confirmation function validates and confirms the day's trades 114. The trading entity 110 then can access the updated data to view their positions 124.

The underlying purpose of the trade confirmation function 114 is to verify accurate trade capture in the trade life cycle process and to agree on transaction terms such as, but not limited to, transaction type, volume, tenor, delivery location, and prices with counter-parties. More particularly, following the trade entry into the trade life cycle process, the trade confirmation function 114 verifies the terms of the transactions for consistency and completeness. The trade confirmation function 114 validates the trades through one or more methods that include, but are not limited to, voice checkout with a broker, verification with the counter-party directly if the trade was consummated without a broker, or with an electronic confirmation if the trade is consummated over an online exchange. After validation of the terms of the transaction, the price curves are validated and the appraisal process groups the trades by among other things, by product, location and tenor. Tenor means the length of time between trade date and the end of the term of a transaction. Tenor differs from the term of a trade which represents the period of time between the start of the transaction (which may be well after trade date) and the end of the transaction. For example, if a trade were conducted on Nov. 1, 2002 for the physical sale of gas between April 2003 and October 2003, the transaction would have a term of 6 months and a tenor of 12 months.

A scheduling function 116 includes actions and processes necessary for scheduling various commodities. For trades that actually will result in the movement of physical commodities, the scheduling function 116 is utilized to provide the schedule services necessary to effectuate the trade. For trades that are only financially oriented, the scheduling function 116 is not necessary. The overall purpose of scheduling is to ensure that the traded commodity is delivered on the correct date with the correct amount of the commodity traded.

Looking at the electric power commodity as an example, the scheduling function 116 first determines the region's scheduling position. Among other things, this process can include identifying available resources, delivery capabilities or the like. The scheduling function 116 then verifies this position with the counter-party; if these positions do not match then it is necessary to reconcile the two positions and make any necessary changes. The scheduling function 116 continually watches for any new trades in order to keep the scheduling chart up to date. The scheduling function 116 also confirms all of the positions by communicating with applicable counter-parties and arranging either to book-out (match a buy and a sell) or arranging the necessary physical paths or delivery mechanisms. Once a trade has been scheduled, the scheduling function 116 will record the paths and match all the positions with the corresponding paths. Once all of the positions have been scheduled, matched-up and booked-out, the scheduling process is complete.

Another example is the natural gas commodity. In this example, the scheduling function 116 contacts the counter-party's scheduling function to verify receipt (purchase) or delivery (sale) point, volume, and to pass along pipeline contract numbers. This usually occurs the day before flow of the commodity through the pipes; not necessarily the day the trade is completed. Once all is confirmed, the scheduling function 116 then schedules the volume on the appropriate pipeline EBB (Electronic Bulletin Board) according to Gas Industry Standards Board (GISB) deadlines. Intraday trades are scheduled via the same process, under different time deadlines. The scheduling function 116 then confirms the flowing volumes on a daily basis.

Other functions that can be included in the trade life cycle process are value and risk analysis and reporting 124 and reconciliation and actualization 122.

On a daily basis, a value and risk analysis and reporting function 124 analyzes and reports the value and risk of an entire portfolio of transactions by computing the current value of the portfolio and changes in this value from the prior day. The changes in value from the previous day are segregated into those changes resulting from movements in prices and those changes resulting from changes in positions and are analyzed accordingly. Further, a value/risk analysis and reporting function 124 performs various analytical procedures to measure the level of market exposure contained within the portfolio. The portfolio values and risk measures are thoroughly validated and analyzed and are subsequently reported in the appropriate reports provided to the trading entity.

Additionally, a value and risk analysis and reporting function 124 can perform independent verification of a large number of pricing parameters and volatility assumptions used in the valuation of the trading portfolio. The input validation consists of comparing price curves and volatility curves for various trading locations against independent, third party sources of information 126. Various sources such as, but not limited to, exchanges, brokers, and industry publications provide the independent price and volatility quotes through the data services function 126. Following a comparison of differences between the trading entity's prices and curves to the external sources, prices and/or volatility assumptions can be changed to reflect third-party data where warranted (i.e., trading entity's computations are materially different) and the portfolio can be revalued utilizing the changes price(s)/volatilities.

A reconciliation and actualization function 122 reconciles expectations or estimates of values as reported daily by a value and risk analysis and reporting function 124 against actual results captured through a settlement function 118. This process is done periodically (in one embodiment monthly), with heightened scrutiny around critical time frames, such as quarter/year-end periods.

The settlement function 118 includes, but is not limited to, “check-out” with counterparties, invoicing, settlement, payment, collection, and cash application. A settlement function 118 confirms net purchases or sales with counter-parties and tries to satisfactorily resolve any discrepancies before invoicing each month. Invoices are separate or combined based on the contractual agreements with the counter-parties. Application of cash receipts is applied to each invoice.

A financial accounting and reporting function 120 includes, but is not limited to, recording of transactions into a general ledger or subledgers as appropriate based on the type of transaction, commodity, counter-party netting, etc. Accounting rules require some transactions to be gross, others to be net, in the income statement and/or the balance sheet. For physical transactions, a financial accounting and reporting function 120 reconciles activity on a periodic basis (i.e. monthly) in the trading life cycle process. Information is provided related to average prices and volumes for variance analysis and management reporting. In addition, a financial accounting and reporting function 120 prepares information required for disclosure in the company's financial statements and notes.

A regulatory reporting and litigation support function 121 includes, but is not limited to, producing periodic (i.e. quarterly) reports to the Federal Energy Regulatory Commission and other agencies. In addition, the regulatory reporting and litigation support function 121 queries historical activity to identify transactions with specific counter-parties or that meet a specific criteria to provide supporting detail required for counter-party bankruptcies, litigation or investigations as requested by the trading entity.

A credit function 128 evaluates and monitors the financial condition and ratings of trade counter-parties. The credit function 128 can analyze each counter-party to determine the acceptable credit exposure. The credit function 128 will negotiate the terms of trades with each counter-party such as, but not limited to, netting, guarantees, and margining. Each counter-parties' credit can be tracked and evaluated for both actual and potential exposure to ensure credit limits are maintained and positions are within the boundaries of the contractual thresholds.

The outsourcing services can also provide value-add services such as, but not limited to, contract administration 140, research and modeling 142, risk management 144, and asset optimization 146.

A contract administration function 140 prepares and reviews draft contracts as requested by a trading entity to provide written documentation of transactions. A contract administration function 140 will draft or review the contract, identify commercial and legal risks, work with a trading entity to ensure that all necessary commercial and legal terms and obligations are included in the contract, and assist with negotiations. A contract administration function 140 will coordinate with the trading entity to obtain contractual provisions, which may included in the contract and implemented by the trading entity. Contracts are reviewed and approved by trading entity prior to execution. Some objectives, but not limited to, of a contract administration function 140 are to ensure that (i) the contract does not violate any law or regulation and (ii) the trading entity understands the commercial and legal risks and obligations associated with a transaction thus allowing the trading entity to make an informed decision whether to accept such risks and obligations.

A research and modeling function 142 can assist a trading entity in developing models and strategies to support energy commodity trading, marketing and risk management. This function can also design systems and processes for evaluation, optimization, and management of a trading entity's energy assets. Research and modeling function 142 seeks for arbitrage opportunities and develops trading strategies. This function is involved in developing new structured products. The purpose of these products is the reduction of long-term risk, which would result in increase of opportunities for asset acquisition and development, as well as for making long-term deals. A research and modeling function 142 could assist in discovering optionality in energy assets as well as building asset pricing models. Generating correct hedges is also a feature of this function.

A risk management function 144 establishes a structure/framework of risk management policies and processes, which delineate the responsibilities trade life cycle process as well as other supporting functions such as, but not limited to, price curve structuring, information technology, and research via the model development and implementation processes. A risk management function 144 works to identify the key market, credit, and operational risks. Based on the identified risk, it then develops appropriate risk measurement methodologies and recommends both the risk metrics as well as the risk limits, which are then adopted by trading entity management, the performance under such limits being monitored by the control organizations. A risk management function 144 examines potential transactions to ensure that the valuation and risk analyses are appropriately performed and that the transaction details appropriately reflect the contractual arrangements and that the transaction is properly captured in trade life cycle process. Also, a risk management function 144 is involved in an exercise of periodic evaluation of the limits, processes and variances from expected performance levels. This exercise is done with a view to achieve improvements and better align the business to meet its goals in rapidly changing environments.

An asset optimization function 146 assists a trading entity in determining the value of any optionality associated with an energy asset. The determined option value provides a measure of total asset (intrinsic+extrinsic) value. Comparing this pricing with market quotes for standard products or structured pricing for custom products provides necessary knowledge to identify arbitrage opportunities that can be captured using Mirant's trading and marketing. An asset optimization function 146 identifies for the trading entity the best methods to trade financial commodities against their physical assets to manage risk and create incremental profits above the intrinsic value. The trading entities' asset positions can be hedged or even reversed through physical and financial trading positioning the trading entity to be on the right side of the commodity cycle at any point in time. In addition, an asset optimization function 146 can provide management of market evolution and regulatory concerns, which provide additional data with which to create value through trading and asset acquisitions or divestitures. By monitoring market design, an overall effect on the economics of a market evolution can be determined and the financial effect of the market change through strategic positions can be captured.

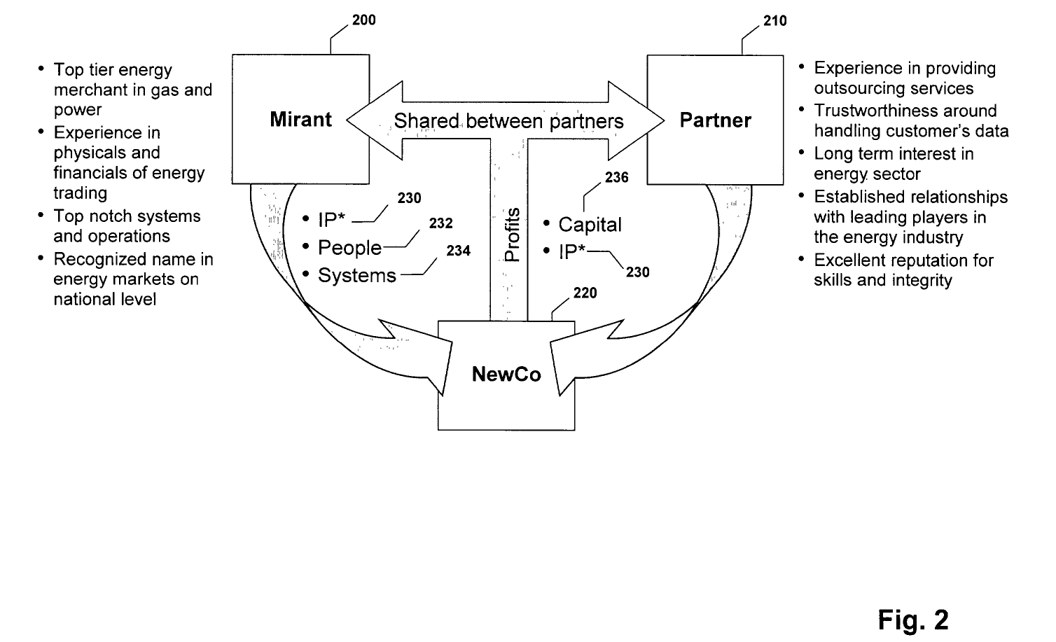

FIG. 2 is a block diagram illustrating and exemplary implementation of the present invention in a joint venture structure. The provision of the services and functionality in the trade life cycles process described in conjunction with FIG. 1 can be provided by a single entity or a group of two or more entities. As previously mentioned, a goal of the present invention is to provide an outsourced capability to smaller entities that want to engage in the trading of energy commodities. To create an atmosphere of trust in the service, it may be necessary to create a new entity that can operate independent of any of the entities that are providing the service. Such a structure helps to remove conflicts of interest that may arise if a single entity is simply outsourcing its own capabilities and thus, create a neutral entity in which a customer can comfortably trust. FIG. 2 illustrates two partners, Mirant 200 and another partner 210 that are jointly providing the trade life cycle process services. Each of the partners creates a separate entity (NewCo 220) that will provide the trade life cycle process services. The partners may contribute to the NewCo 220 in a variety of manners including, but not limited to, the provision of intellectual property 230, human resources or people 232, systems or other physical assets such as office space and equipment 234 and capital 236. The ownership of NewCo 220 is shared between each of the partners and will share in the profits or losses generated or incurred by the NewCo 220.

### CONCLUSION

The present invention provides a cost-effective method for providing transactional and value-add services for trading energy commodities. The present invention provides a viable solution plus a value proposition that is being sought by energy producers, distributors, marketers and consumers but has not yet been introduced to the energy marketplace.

Customers of these outsourcing services are likely to include, but are not limited to, energy producers, distributors, marketers, and consumers that are or would like to be involved in trading. Other potential customers are the large financial institutions that lack the expertise in physical scheduling and delivery. Potential customers of such outsourcing services will be referred to as trading entities throughout the remainder of this document.

A trade is a deal between a trading entity and counter-party. This invention is a method for providing outsourcing services to a plurality of trading entities. These services can be offered by a single standalone entity or jointly with a plurality of partners. These services are provided to a trading entity through a method of capturing a trade into a trade life cycle process, confirming the trade, determining whether the trade is financial or physical, if physical scheduling delivery of the commodity, closing the trade, and preparing applicable reports and data files.

The present invention is further enhanced by providing a value added services to the trading entity such as research and modeling services, asset optimization services, risk management services, and contract administration services.

What is claimed is:

1. A method for providing trade outsourcing services to a plurality of trading entities, the provision of the trade outsourcing services being jointly provided by a plurality of partners and the trading outsourcing services being offered to a plurality of trading entities for facilitating the trading of energy commodities, the method comprising the steps of:
each of the plurality of partners pooling resources to create an outsourced trading company for providing the trade outsourcing services;
the outsourced trading company receiving a trade entry from a least one of the plurality of trading entities;
capturing the trade into a trade life cycle process;
confirming the trade;
determining the trade type;
if the trade type is a physical type, scheduling the delivery of the commodity;
closing the trade; and
preparing applicable reports and data files.

2. The method of claim 1, further comprising the steps of:
calculating price curves to provide information to the plurality of trading entities;
translating of transaction data into mark-to-market accounting terms;
performing valuation analysis based on trade entry and market parameters; and
performing risk analysis based on the trade entry and market parameters.

3. The method of claim 1, where in the step of scheduling the delivery of the commodity further comprises the steps of:
scheduling the delivery of the commodity;
balancing positions;
delivery guarantees;
access to transportation logistics; and
drawing on transport contracts.

4. A method for providing trade outsourcing services to a plurality of trading entities for facilitating the trading of energy commodities, and wherein each trading entity does not have the resources or capability of performing the trading service on its own, the method comprising the steps of:
providing a trading entity input interface for receiving a trade entry, whereby any particular trading entity of the plurality of trading entities can provide the trade entry and the trade entry at least identifies an energy commodity;
providing a trading entity output interface for providing trade related information to any particular trading entity of the plurality of trading entities, the trade related information comprising scheduling information, reporting information and trading parameter information;
processing the trade entry by confirming the trade entry and scheduling any necessary deliveries associated with the trade entry; and
closing the trade.

5. The method of claim 4, wherein the step of providing a trading entity output interface further comprises providing research and modeling information.

6. The method of claim 4, wherein the step of providing a trading entity output interface further comprises providing asset optimization information.

7. The method of claim 4, wherein the step of providing a trading entity output interface further comprises providing risk management information.

8. The method of claim 4, wherein the step of providing a processing the trade entry further comprises developing and providing contract administrative services.

9. The method of claim 4, wherein the step of providing a processing the trade entry further comprises developing and providing demand management and load shape products.

10. The method of claim 4, wherein the step of providing a processing the trade entry further comprises developing and providing hedge treatment and hedge effectiveness assessments.

11. The method of claim 4, wherein the step of providing a processing the trade entry further comprises developing and providing counter-party credit evaluations and analysis.

12. A method for providing trade outsourcing services to a plurality of trading entities for facilitating the trading of energy commodities, the method comprising the steps of:
receiving a trade entry from a least one of a plurality of trading entities, the trade entry identifying an energy commodity;
confirming the trade;
classifying the trade type as either a physical type or a financial type;
for trades that are classified as physical types:
scheduling the delivery of the commodity; and
effectuating the delivery of the commodity;
closing the trade; and
preparing applicable reports.

13. A bundled commodity trading service existing as a single, stand alone entity, and being operative to support the trading of energy commodities for a plurality of trading entities by:
receiving a trade entry from a least one of a plurality of trading entities, the trade entry identifying an energy commodity;
confirming the trade entry;
classifying the trade type of the trade entry;
for trades that are classified as physical types:
scheduling the delivery of the commodity; and
effectuating the delivery of the commodity; and
closing the trade.
